(19) United States
(12) Patent Application Publication
(10) Pub. No.: US 2013/0226696 A1
(43) Pub. Date: Aug. 29, 2013

(54) SOCIAL DISCOVERY SYSTEM USING COMPUTING DEVICE PROXIMITY

(71) Applicant: MeetMe, Inc., (US)

(72) Inventor: Geoffrey Cook, Pennington, NJ (US)

(73) Assignee: MEETME, INC., New Hope, PA (US)

(21) Appl. No.: 13/735,803

(22) Filed: Jan. 7, 2013

Related U.S. Application Data
(60) Provisional application No. 61/603,092, filed on Feb. 24, 2012.

(51) Int. Cl. G06Q 30/02

(52) U.S. Cl. CPC G06Q 30/0251
USPC 705/14.49

(57) ABSTRACT

Technologies for providing a social discovery system enable a user to complement his or her real world activities with online services. For example, the user is associated with a computing device and a user context. A server connected to the computing device determines an offer for a service based on the computing device and the user context. The server may limit the acceptance of the offer to predefined real world physical conditions. The conditions may require the user to accept the offer while being located in proximity of a second user who has received a similar offer. The server receives from the computing device a request accepting the offer and demanding an activation of the service. The server compares the request to the conditions, authenticates the computing device, and activates the service.

### CROSS REFERENCE TO RELATED APPLICATIONS

This application claims benefit under 35 U.S.C. §119(e) of U.S. Provisional Application No. 61/603,092, filed Feb. 24, 2012, the content of which is incorporated herein by reference in its entirety.

### BACKGROUND

The spread of personal electronic devices and accessibility to data via the Internet and other networks have enabled access and use of an ever increasing number of online services. Popular online services include social media networks that provide users with a rich variety of applications. Such social media networks empower a user to build a virtual world customized to his or her needs, aspirations, and preferences. The virtual world allows the user, in some or many instances, to substitute real world services with online applications. For example, the user can log-in to a social media network such as MYYEARBOOK to take advantage of the offered online applications. The online applications allow the user to chat with friends, upload pictures, view blogs and profiles, etc. As such, the user need not meet the friends face-to-face, but can instead catch-up with their activities via the social network. Similarly, a university professor can set-up an online classroom by running, for example, a BLACKBOARD application. The online classroom eliminates the need for a physical meeting between the professor and the students. As a further example, in a busy holiday shopping season, a shopper can avoid the mall rush and can instead surf the web, access his or her favorite online retailers, and purchase the desired products and gifts.

As the type, number, and availability of online services keep expanding, there is a real likelihood that the user's virtual world may replace certain fundamental aspects of the real-world. These aspects include, for example, natural communications, in-person meetings, and face-to-face gatherings.

### SUMMARY

A goal of the present invention is to provide a means for bridging a user's virtual and real worlds, and for tailoring building blocks of a user's virtual world such that it complements the real world. In various embodiments, systems, methods, and computer-readable media are disclosed for providing a social discovery environment that offers and activates online actions or services based on real world encounters of online users.

In an illustrative embodiment, a service provider and a computing device associated with a user can be connected to the Internet. Based on a user context and an identification of the computing device, the service provider may tailor and transmit an offer for an online service to the computing device. The user context may include, for example, an account associated with the user, proximity of the computing device to other computing devices, and a geographic location associated with the computing device.

The service provider may require that the offer be accepted according to a real world activity or a physical condition such as a face-to-face meeting between the user and at least a second user with a similar offer. As such, the service provider may deem an acceptance valid when both users accept the offer at substantially the same time while being in proximity or geographically located within a certain distance of each other.

The acceptance can comprise a request from the computing device to the service provider for an activation of the service. The service provider can determine the time at which the request was made and the geographic location of the computing device at that time. For example, the time and geographic location can be included in the request or can be derived from a third party such as a mobile network operator. Such information can be determined using various techniques such as receiving satellite positioning system coordinates (e.g., GPS data), applying cellular triangulation or WiFi access point interpolation, or processing geographical tags. Additionally, the service provider can determine the proximity of the users based on, for example, near field communication techniques between the associated computing devices.

The service provider can verify whether the request meets the acceptance requirement. For example, the service provider may compare the request to a request associated with the second user and may determine that both requests were made at substantially the same time while the users were in proximity of each other or at substantially the same geographic location. Additionally, the service provider can authenticate the user and can determine a service level based on, for example, the user account and the computing device identification. The service level can comprise a denial, partial, or full activation of the service. Thereafter, the service provider can activate the service, transmit a response to the computing device, and update the user account.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The systems, methods, and computer media for providing a social discovery environment in accordance with this specification are further described with reference to the accompanying drawings in which:

FIG. 1 depicts an example computing system wherein aspects of the present disclosure can be implemented.

FIG. 2 depicts an example communication system in which various embodiments of the present disclosure may be implemented.

FIG. 3 depicts an illustrative architecture for providing an online action.

FIGS. 4A, 4B, and 4C depict an example embodiment for offering, accepting, and activating an online action.

FIG. 5 depicts an example operational procedure for providing an online action.

### DETAILED DESCRIPTION OF ILLUSTRATIVE EMBODIMENTS

Specific details are set forth in the following description and figures to provide a thorough understanding of various embodiments of the disclosure. In the drawings, similar symbols identify similar components, unless context dictates otherwise. Certain well-known technology details, such as computing and software technologies, are not set forth in the following description to avoid unnecessarily obscuring the various embodiments. Those of ordinary skill in the relevant art will understand that they can practice other embodiments of the disclosure without departing from the scope of the subject matter presented herein. Finally, the various techniques described herein can be implemented in hardware, software, or a combination thereof.

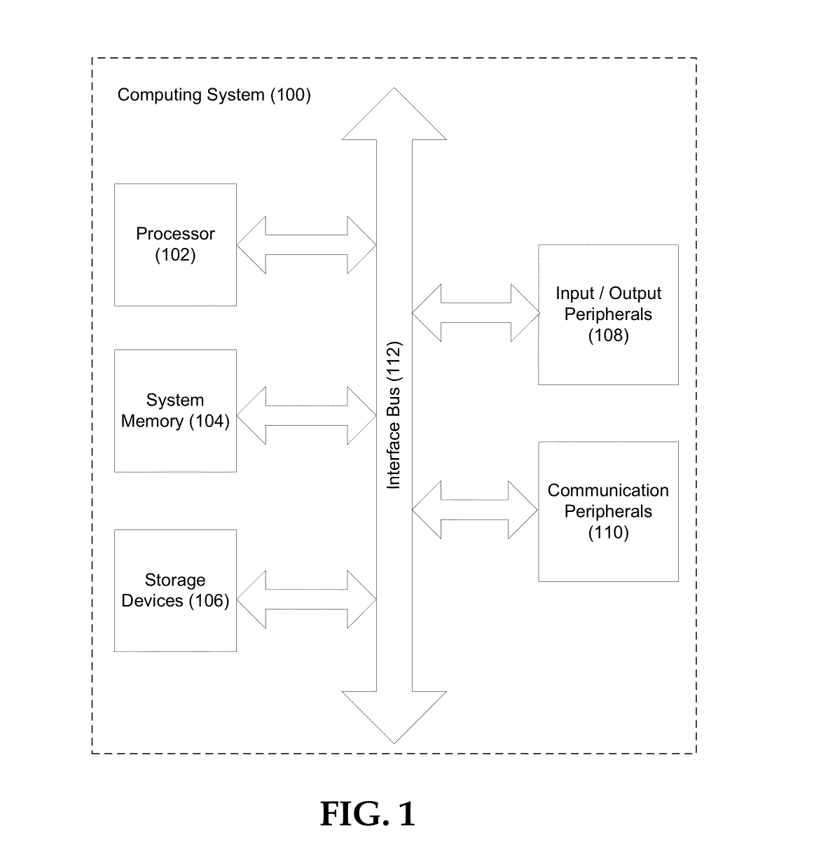

FIG. 1 depicts an example computing system 100 wherein aspects of the present disclosure can be implemented. In a basic configuration, computing system 100 may include at least a processor 102, a system memory 104, a storage device 106, input/output peripherals 108, communication peripherals 110, and an interface bus 112. Interface bus 112 is configured to communicate, transmit, and transfer data, controls, and commands between the various components of computing system 100. System memory 104 and storage device 106 comprise computer-readable storage media, such as RAM, ROM, EEPROM, hard drives, CD-ROMs, optical storage devices, magnetic storage devices, flash memory, and other tangible storage media. Any of such computer-readable storage medium can be configured to store instructions or program codes embodying aspects of the disclosure. Additionally, system memory 104 comprises an operation system and applications. Processor 102 is configured to execute the stored instructions and can comprise, for example, a logical processing unit, a microprocessor, a digital signal processor, and the like.

Further, input and output peripherals 108 include user interfaces such as a keyboard, mouse, screen, microphone, speaker, printer, scanner, other input/output devices, and computing components such as digital-to-analog and analog-to-digital converters, graphical processing units, serial ports, parallel ports, and universal serial bus. Input/output peripherals 108 may be connected to processor 102 through any of the ports coupled to interface bus 112. Finally, communication peripherals 110 are configured to facilitate communication between computer system 100 and other computing devices over a communications network. Communication peripherals 110 include, for example, a network interface controller, modem, various modulators/demodulators and encoders/decoders, wireless and wired interface cards, antenna, and the like.

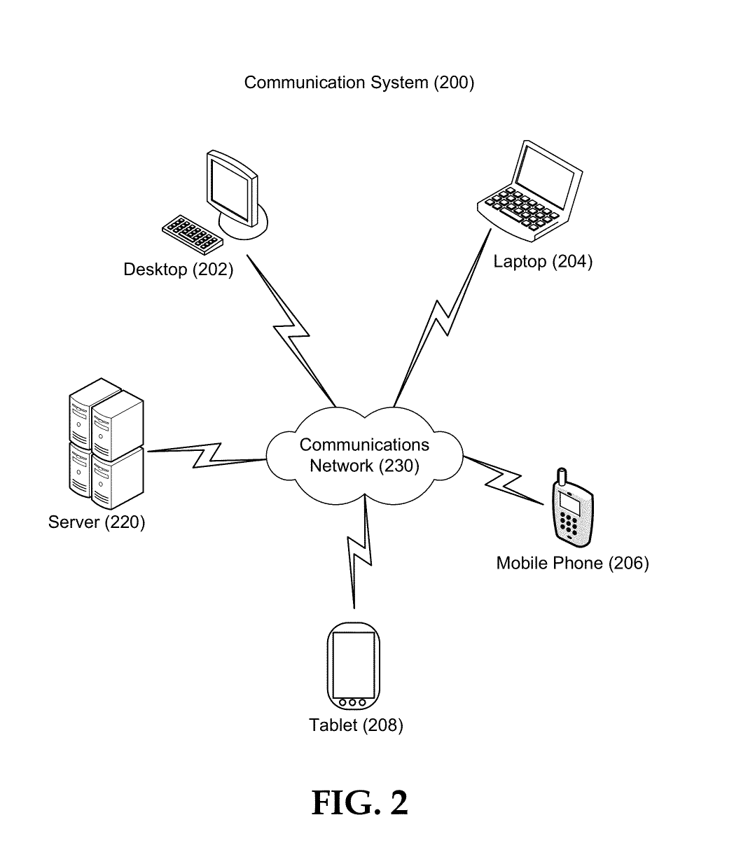

FIG. 2 depicts an example communication system 200 in which various embodiments of the present disclosure may be implemented. Communication system 200 can be configured to provide online services as disclosed herein and can comprise computing devices 202 (desktop computer), 204 (laptop computer), 206 (mobile phone), and 208 (tablet), server 220, and communications network 230. Each of the computing devices and server 220 may comprise some or all components of the computing system 100 of FIG. 1. Communications network 230 may be any type of network that is suitable for providing communications between the computing devices and server 220 and may comprise a combination of discrete networks, which may use different technologies. For example, communications network 230 comprises local area networks (LANs), wide area networks (WANs), telephony networks, cellular networks, WiFi networks, fiber-optic networks, or combinations thereof. In an example embodiment, communications network 230 comprises the Internet and any networks adapted to communicate with the Internet. Communications network 230 may be configured as a means for transmitting data between the computing devices and server 220.

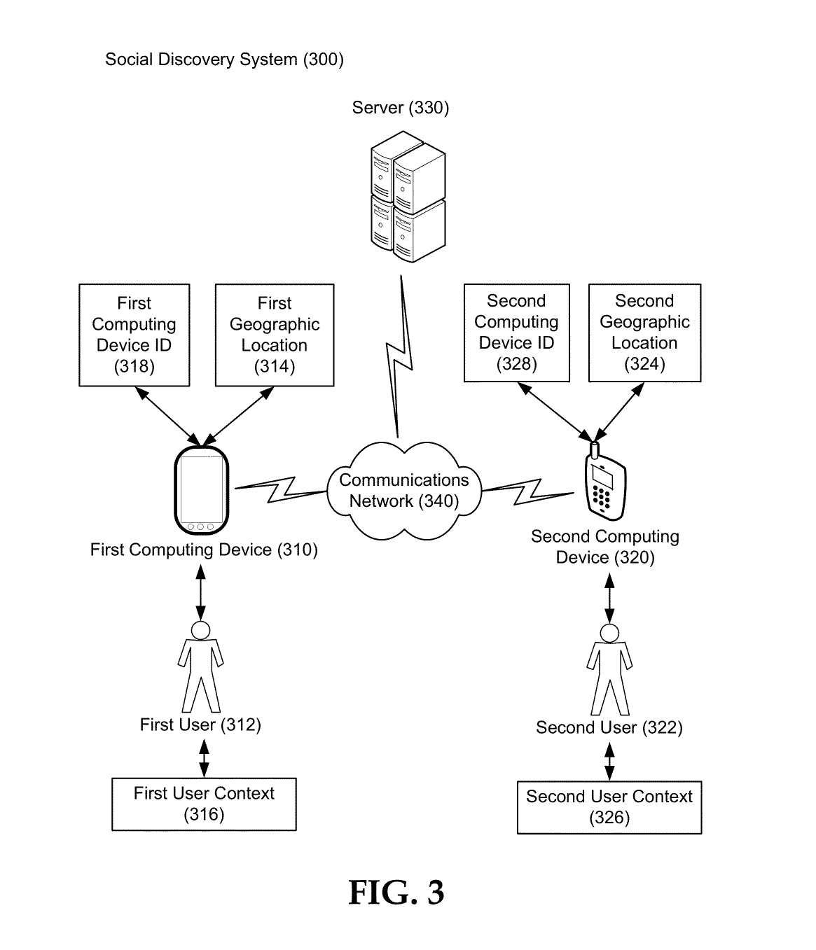

FIG. 3 depicts an illustrative architecture for providing an online action. In particular, FIG. 3 discloses a social discovery system 300 that comprises computing devices, such as a first computing device 310 and a second computing device 320, a server 330, and a communications network 340. Computing devices 310 and 320 may comprise some or all components of any computing devices of FIGS. 1 and 2. For example, first computing device 310 is a tablet, and second computing device 320 is a mobile phone. Additionally, first and second computing devices 310 and 320 are associated with a first user 312 and a second user 322, respectively. Similarly, server 330 and communications network 340 may comprise some or all components of server 220 and communications network 230 of FIG. 2, respectively. As such, computing devices 310 and 320 and server 330 are connected over communications network 340.

In an embodiment, server 330 can transmit an offer for an action to some or all computing devices. The transmission may depend on privacy settings associated with users of the computing devices. In one scenario, first and second computing devices 310 and 320 receive the offer from server 330 through communications network 340. Additionally, the offer comprises, for example, an advertisement while the action comprises a service that can be activated for the users, such as downloading an online application to the computing devices or providing a real world deal. In a further scenario, the action is based on an incentive-based system, where an acceptance of the offer results in rewards. The rewards comprise points, coupons, virtual currency, and the like that are associated with the offer or the action. As an illustration, the offer comprises an advertisement for a coffee shop with a reward for a half-off coupon and twenty-five point credits. First user 312 accepts the offer, the coupon is downloaded to first computing device 310 and twenty-five points are credited to an online account. First user 312 presents the coupon via first computing device 310 at the coffee shop where the coupon is scanned and redeemed. Thereafter, first user 312 uses the twenty-five points to effectuate an online transaction such as purchasing a coffee mug off a website associated with the coffee shop.

Further, server 330 can tailor the offer to the computing devices and the users associated therewith. The tailoring of the offer comprises selecting an offer and/or a computing device based on various factors and transmitting the selected offer to the selected computing device. The factors comprise, for example, a list of available offers stored in a database associated with server 330, the actions associated with the available offers, an identification of the computing device such as its internet protocol (IP) address, prior communications between the computing device and server 330, prior offers sent to the computing device, and prior offers accepted by the computing device. Additionally, the factors may comprise a user context. The user context comprises, for example, a user account associated with a user of the computing device. The user account identifies the user, describes his or her profile (e.g., gender, age, social status, list of friends, contacts, calendar, etc.) and preferences (e.g., activities, hobbies, aspirations, etc.), provides a history of transactions with server 330, and presents a list of services that the user is subscribed to, activities the user is scheduled to attend, etc. The user context may further comprise a time stamp, a geographic location, and proximity information to other users. Such information is determined based on the computing device as described herein below.

Moreover, transmitting the offer to the computing devices can be automatic or on-demand An automatic transmission comprises sending the offer independently of the computing devices. In other words, the offer is pushed to the computing devices regardless of whether the computing devices requested it or not. An on-demand transmission comprises sending the offer based on requests from or settings at the computing devices. For example, the user can manually request through the computing device a type of offer by accessing an application or a website associated with server 330 and downloading the offer. Additionally or alternatively, the user can have a setting enabled on the computing device that pulls offers from server 330 based on the user context. For example, as the user walks into a clothing store, the computing device transmits its location to server 330 and requests an offer associated with the location. In turn, server 330 maps the location to the identity of the clothing store, retrieves an offer associated with the clothing store, and transmits the offer to the computing device.

As an illustration, first computing device 310, first user 312, second computing device 320, and second user 322 are associated with a first computing device identification 318, a first user context 316, a second computing device identification 328, and a second user context 326, respectively. User context 316 includes a geographic location 314 determined based on a geographic location of first computing device 310. Similarly, second user context 326 includes a second geographic location 324. Based on computing device identifications 318 and 328, server 330 determines that first computing device 310 is very active by, for example, determining that the number of previously accepted offers therefrom is relatively high. Additionally, based on first user context 316, server 330 determines that first user 312 is a third-year college student, has final exams in a week, and is currently located at a bookstore. As such, server 330 transmits to first computing device 310 an offer for a standard discount (e.g., 10% off) redeemable at the bookstore. In comparison, based on second computing device identification 328 and second user context 326, server 330 determines that second user 322 is a wine enthusiast that has not redeemed any previous offer. Server 330 also determines that second user 322 is nearby a wine tasting room a little bit after five o'clock on a Friday afternoon. As such, server 330 transmits to second computing device 320 an offer for a high discount (e.g., 60% off) redeemable at the wine tasting room. In an additional illustration, first and second user contexts 316 and 326 include proximity information indicating that first and second computing devices 310 and 320 are within a close range of each other and include calendar information indicating that first and second users 312 and 322 are scheduled for a dinner date in the next hour. As such, server 330 determines that first and second users 312 and 322 are co-located and transmits to both a coupon for a popular restaurant. Further, server 330 takes advantage of first and second geographic locations 314 and 324 to refine the coupon to a popular restaurant in walking distance of first and second users 312 and 322.

In an embodiment, the user context comprises a geographic location. The geographic location is determined based on the geographic location of the computing device associated with the user. For example, computing devices 310 and 320 are equipped with components and applications for processing location information received from a satellite-based (e.g., global positioning system), cellular triangulation, or wireless access point interpolation system. Alternatively or additionally, geographical tag (also referred to as “geotag”) hardware and software are embedded in the computing devices 310 and 320. A geotag comprises geographical identification metadata added to various captured media such as photographs, videos, websites, text messages, really simple syndication (RSS) feeds, and the like. As such, geotag techniques are applied to compute the geographic locations.

The user context also comprises a time stamp. The time stamp indicates the time at which the geographic location was processed. For example, the time stamp is time data comprised in the GPS coordinates, information received with the cellular triangulation or wireless point interpolation, or metadata embedded in the geotag.

The geographic location and the time stamp information can be transmitted from the computing devices to server 330. For example, the computing devices send the information to server 330 continuously or on-demand. Alternatively or additionally, server 330 retrieves the information from a third-party provider that has access to the information. The third-party provider comprises, for example, a mobile network operator or an Internet service provider and transmits the information to server 330 continuously or on-demand. The transmission of the information between the computing devices, server 330, and/or the third-party provider may be subject to privacy restrictions. Such restrictions can be controlled by the users and include, for example, a resolution level, a sharing level, and the like. In an illustrative scenario, first user 312 transmits first geographic location 314 to server 330 with a resolution of few feet and enables server 330 to share the information with second computing device 320 and with the third-party provider. In comparison, second user 322 does not transmit second geographic location 324 to server 330, but allows server 330 to retrieve the information with a city-level resolution from the third-party provider. Furthermore, the transmission of the information may depend on the user context and the computing device identification. For example, first user context 316 and first computing device identification 318 are used to authenticate the connection between first computing device 310 and server 330 prior to exchanging the information.

Server 330 transmits the offer to a number of computing devices, such as first computing device 310 and second computing device 320. Additionally or alternatively, server 330 transmits the offer to a smaller number of computing devices, such as first computing device 310, which may share the offer with other computing devices within social discovery system 300, such as second computing device 320. The offer from first computing device 310 to second computing device 320 is sent over communications network 340. As such, first and second computing devices 310 and 320 may receive the same or similar offers. The same offers are offers from server 330 to first and second computing devices 310 and 320 for the same action or service and are subject to the physical conditions. The similar offers are offers transmitted from server 330 to first and second computing devices 310 and 320, need not comprise the same action or service, and are subject to the physical conditions. For example, as described herein above, server 330 may tailor each offer to include a specific action based on the user context. First computing device 310 may receive an offer for a bookstore discount while second computing device 320 may receive an offer for a wine tasting room. Although the actions are different (discount at a bookstore compared to a discount at a wine tasting room), the two offers are considered similar if they are received from the same server (e.g., server 330) and if they are subject to the physical conditions.

In an embodiment, an acceptance of the offer may depend on real-world physical conditions, such as geographic and time conditions. The conditions comprise requiring users, such as first and second users 312 and 322, associated with computing devices, such as first and second computing devices 310 and 320, to be located within a predefined geographic range and to accept the offer within a predefined time range. The predefined geographic range requires the users or the associated computing devices to be within a certain distance relative to each other. For example, the required distance between first and second computing devices 310 and 320 is no more than three feet. The predefined time range requires the users or the associated computing devices to accept the offer within a certain time difference relative to each other's acceptance. For example, the acceptance by first user 312 is no more than ten seconds earlier or later than the acceptance by second user 322. Further, meeting the conditions to create a valid acceptance can be accomplished in various orders. For example, first and second users 312 and 322 may simultaneously or substantially simultaneously meet the geographic and time conditions (e.g., at the same time or substantially the same time, the users co-locate the computing devices and accept the offer). Additionally, the users may meet the geographic and time conditions in sequence. For example, first and second users 312 and 322 first accept the offer within the predefined time range and subsequently become located within the predefined geographic range. Similarly, first and second users 312 and 322 are first located within the predefined geographic range and subsequently accept the offer within the predefined time range.

Alternatively, the acceptance of the offer from any user or any computing device may suffice. In such scenario, similar geographic and time conditions as herein above apply. The predefined time range is additionally or alternatively the time range within which accepting the offer and meeting the geographic condition must be accomplished. Meeting the geographic and time conditions to create a valid acceptance can be accomplished in various orders. For example, first user 312 is the only accepting user, the predefined time range is an hour, and predefined geographic range is ten feet. As such, first user 312 first accepts the offer, but only has one hour from that point in time to subsequently move and be within ten feet of second user 322 in order for the acceptance to be valid. Alternatively, first user 312 is first within ten feet of second user 312 and starts moving away therefrom dissatisfying the geographic condition. At that point in time, the time condition is triggered. Thus, for the acceptance to be valid, first user 312 needs to accept the offer within one hour from that time. Finally, first user 312 comes within ten feet of second user 322 and, at substantially the same time, accepts the offer.

Additionally, the predefined geographic and time ranges may also comprise conditions for the users to meet at a certain geographic location and at a certain time indicated by server 330. For example, server 330 requires first and second computing devices 310 and 320 to be located at a certain venue, such as a theatre, for a certain time, such as ninety minutes associated with a comedy show playing at the theatre.

As an illustration, server 330 transmits to first and second computing devices 310 and 320 an offer for a coupon that is redeemable at a restaurant. The value of the coupon can be the same or can be different for each user 312 and 322. The acceptance has two conditions. First, first and second users 312 and 322 need to be co-located when accepting the offer. Second, first and second users 312 and 322 need to redeem the offer at the restaurant within a certain time period such as six hours. As such, first user 310 meets second user 322 at second user 322's house. At that point, first and second users 312 and 322 accept the offer, meeting the first condition. Subsequently, first and second users 312 and 322 drive to the restaurant and redeem the coupon within the required six hours. Otherwise, the coupon expires, the acceptance is not complete, and first and second users 312 and 322 can no longer take advantage of the offer.

In an embodiment, the predefined geographic range can account for inaccuracies associated with determining the geographic location. For example, if cellular triangulation is used to determine first geographic location 314, this technique has a defined accuracy (e.g., three yards). As such, the predefined geographic range comprises a threshold to offset the defined accuracy (e.g., the predefined geographic range may be at least three yards). Additionally, the predefined geographic range can account for the user preferences. The preferences can be derived from the user context. For example, if second user 312 only allows server 330 to determine geographic location 324 within a street-level resolution, then the predefined geographic range comprises a street block range.

Furthermore, the predefined time range can account for a time delay within social discovery system 300. For example, the time delay stems from latencies associated with communications network 340 and from available processing resources at server 330 and computing devices 310 and 320. As such, the predefined time range comprises an offset that corresponds to the time delay. In addition, the predefined time range depends on a combination of, for example, the nature of the offer, the acceptance method, and the user context. For example, if first and second users 312 and 322 accepted the offer but user contexts 316 and 326 indicate that first and second users 312 and 322 are two miles apart and are walking toward each other in order, then the predefined time range is an hour. In contrast, if user contexts 316 and 326 indicate that first and second users 312 and 322 were co-located when the offer was accepted, then the predefined time range is a few seconds.

In an embodiment, the acceptance can be sent to server 330 as a request for the service comprised in the offer. The request may identify the offer and the service and may comprise activation data. The activation data comprises, for example, a combination of the user context, the computing device identification, the geographic location, and the time stamp. Server 330 uses some or all of the activation data. For example, in one scenario, server 330 uses the received geographic location and time stamp to determine whether the geographic and time conditions are met. In another scenario, server 330 alternatively or additionally estimates the geographic location and the time stamp. In such scenario, server 330 requests the information from the third-party provider or retrieves the information from a database associated with server 330. Additionally, server 330 estimates the time at which the request was made by the computing device or the time at which the request was received by server 330. Such estimated time can be used in conjecture with the time stamp. As such, when server 330 receives the geographic location and the time stamp and estimates the same information, server 330 can use both sets of information to determine whether the service should be activated or not. For example, server 330 compares the information to derive offsets and determines whether the offsets fit within a predefined error margin. When the offsets exceed the predefined error margin, server 330 declines to activate the service even if the geographic and time conditions are met. Such determination prevents, for example, a scenario where a hacker attempts to trick server 330 by sending a forged or false request.

Server 330 receives an individual request from each computing device such as a first request from first computing device 310 and a second request from second computing device 320. Such individual requests include the information described herein above. Alternatively or additionally, server 330 receives a group request. The group request comprises an aggregation of the individual requests. For example, second computing device 320 transmits its request to first computing device 310. In turn, first computing device 310 compiles the received request with its own request to create the group request and transmits the group request to server 330. Second computing device 320 need not send its individual request to server 330. Server 330 processes the received group request as a group activation or derives the individual requests therefrom and processes each individual request as an individual activation. The group activation comprises activating the service for all corresponding computing devices. For example, when all individual requests comprised within the group request meet the geographic and time conditions, server 330 activates the service to all corresponding computing devices. On the other hand, the individual activation comprises an activation of the service for the corresponding computing device independently of the activation of the service for the other computing devices.

In an embodiment, activating the service may comprise server 330 comparing the received and/or estimated geographic location and time stamp to the geographic and time conditions. The comparison comprises accounting for error margins and inaccuracies as described herein above. When the geographic location is within the predefined geographic range and when the time stamp is within the predefined time range, server 330 activates the service corresponding to the received request.

Furthermore, the activation may comprise an authentication of the computing device and the user. For example, server 330 retrieves first computing device identification 318 and first user context 316 from the request of first computing device 310. Server 330 uses, for example, first computing device identification 318 to determine whether computing device 310 is registered with server 330 and whether computing device 310 has a history of invalid connections. Similarly, server 330 retrieves the user account and the user profile from user context 316 and determines whether first user 312 has a registered account and a status of such account. Server 330 also determines past transactions, user preferences, and the like based on the user profile. For example, server 330 declines to activate the service if the user is not registered or if first user 312 has redeemed the service in a past transaction.

In an embodiment, server 330 may transmit a response back to the computing device. The response provides a status of the activation. The response comprises, for example, a window displayed on the computing device's screen with an appropriate and descriptive message about the activation. If the service is activated, the response further includes data based on the requested or activated service. For example, if the requested service is for a file download, then the response initiates the file download from server 330 or the appropriate file source to the computing device. Similarly, if the requested service is for an application, then the corresponding executable file is downloaded to the computing device. The response also includes further instructions for using the service, provides the computing device access to an online service, redirects the computing device to another server and provides the other server with the authentication credentials of the computing device, and the like.

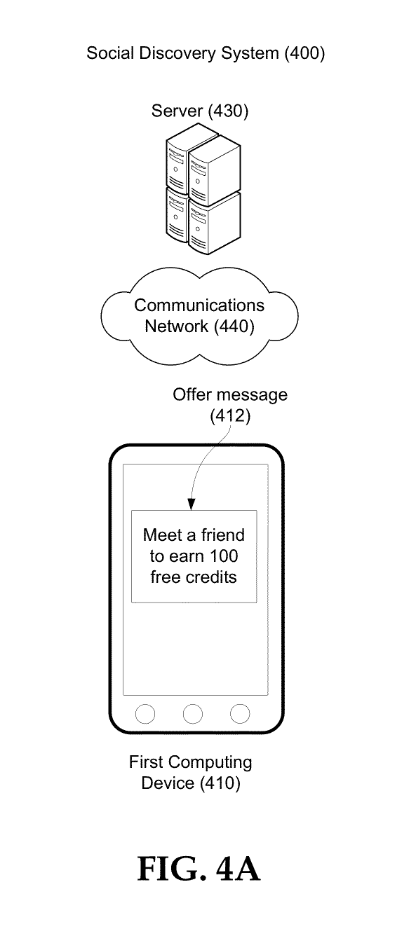

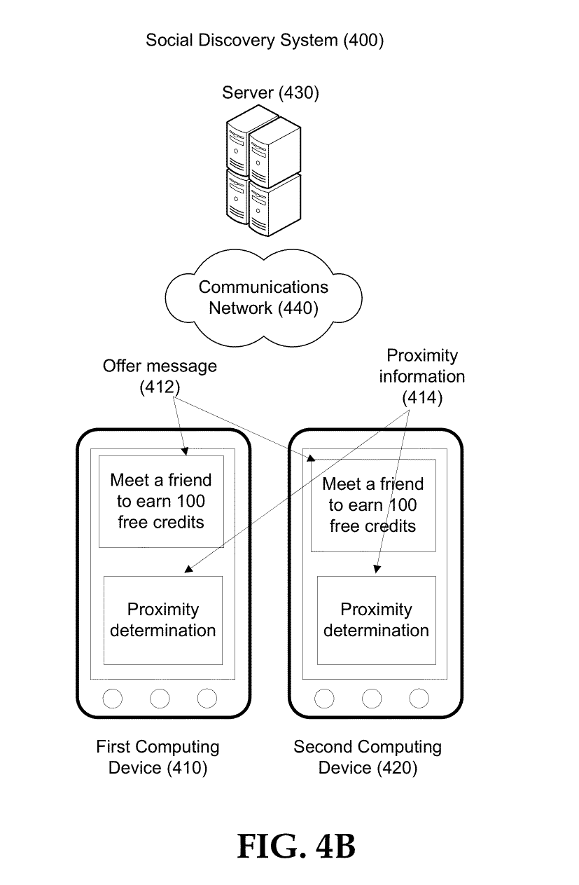

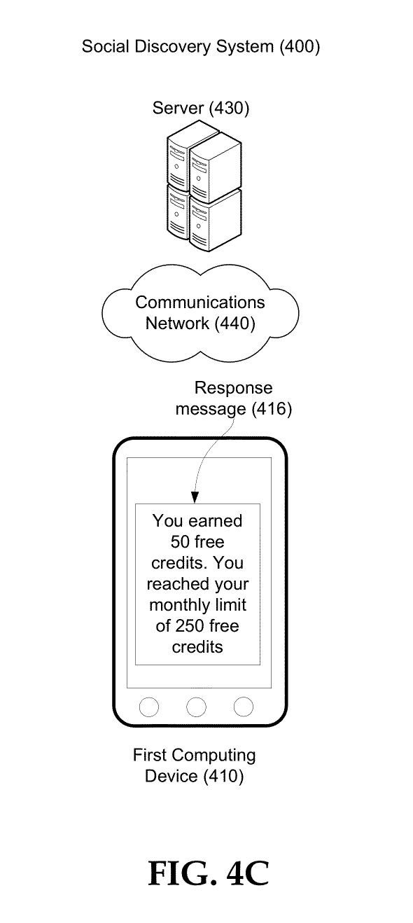

FIGS. 4A-C depict an example embodiment for offering, accepting, and activating an online action. More particularly, FIGS. 4A-C depict a social discovery system 400 that comprises a first computing device 410, a second computing device 420, a server 430, and a communications network 440. The elements of social discovery system 400 may comprise some or all components of social discovery system 300 of FIG. 3. In an embodiment, first computing device 410 is associated with a first user and comprises a mobile smartphone that includes proximity-based hardware and software. Additionally, first computing device 410 comprises an application and a user account for a social media network. Second computing device 420 has a similar, but not necessarily the same, hardware and software configuration as first computing device 410 and is associated with a second user.

The proximity-based hardware and software are configured to enable first and second computing devices 410 and 420 to identify and communicate with each other and with other nearby computing devices and/or systems. The configuration includes, for example, the use of near field communications (NFC). NFC is a set of standards for establishing radio communication between computing devices by touching them together or by bringing them into close proximity of about a few inches. Once the radio communication is established, proximity information 414 is exchanged between the computing devices. Proximity information 414 comprises information related to the user contexts, the computing device identifications, the offers received at each computing device, and the like. Other technologies and techniques can be used in lieu or in addition to NFC. Such technologies include short distance communication (e.g., Bluetooth), optical communication (e.g., infrared), and radio frequency identification (RFID). Moreover, the proximity-based hardware and software configuration can include various types of sensors configured to detect and exchange proximity information 414. These sensors can be a combination of optical, motion, magnetic fields, pressure, electrical fields, or sound sensors. For example, first computing device 410 comprises an optical sensor configured to scan and read tags and barcodes, while second computing device 420 comprises such a tag identifying second computing device 420. Thus, by scanning second computing device 420, first computing device 410 determines that the two computing devices are in close proximity and receives the identification of second computing device 420.

FIG. 4A depicts an offer message 412 received by the first computing device 410. The offer depends on the application and the user account. For example, server 430 determines that first computing device 410 is running a MYYEARBOOK application and that the first user has an interest in meeting others. Server 430 tailors offer message 412 accordingly. For example, offer message 412 states, “Meet a friend to earn 100 free credits.” As such, the offered service or action is free credits that can be used as virtual currency on the MYYEARBOOK social media network and the condition is to meet a friend. Offer message 412 is displayed, for example, as a banner located within a window of the MYYEARBOOK application or any other application running on first computing device 410. As described herein above, the offer can also be tailored based on the proximity of first and second computing devices 410 and 420 and/or the corresponding geographic locations. The first user has an interest in the offer and desires to accept it. Thus, the first user meets the second user who has received a similar offer on second computing device 420 as illustrated in FIG. 4B. As discussed herein above, the similar offer received at second computing device 420 need not be for the same action in the offer received at first computing device 410.

FIG. 4B depicts a request for the action transmitted from first and second computing devices 410 and 420 to server 430 and indicating an acceptance of the offer. The acceptance comprises utilizing the proximity-based hardware and software to derive proximity information 414 and to determine that first and second computing devices 410 and 420 are in close proximity. For example, first and second computing devices 410 and 420 exchange proximity information 414 using NFC and transmit exchanged proximity information 414 within the request to server 430 over communications network 440. Additionally or alternatively, proximity information 414 can be derived from a third-party provider. For example, the third-party provider is a third computing device such as an electronic reader adapted for NFC communication or for RFID data exchange. The third-party provider can also be located at a venue, such as a restaurant or coffee shop, within the vicinity of the first and second users. First computing device 410 communicates with the third-party provider to exchange proximity information 414 and transmits such information to server 430. In parallel or subsequently, second computing device 420 also does the same. Similarly, the third-party provider can transmit exchanged proximity information 414 and the request accepting the offer to server 430. In turn, server 430 compares proximity information 414 received from first and second computing devices 410 and 420, and/or the third-party provider and determines that first and second computing devices 410 and 420 are in close proximity. As a further illustration, the third-party provider can be a tag or barcode configured to direct computing devices to an application or website associated with server 430. As such, first and second computing devices 410 and 420 scan the third-party provider within a time period of each other. Based on the scanning and/or the connection to the application or the website, server 430 ascertains that first and second computing devices 410 and 420 are in proximity of each other if the time period is within a predefined time range (e.g., a few seconds).

As such, the request accepting the offer comprises proximity information 414. Additionally and as described herein above, the request comprises individual requests corresponding to the computing devices or comprises a group request corresponding to an aggregation of the individual requests. Further, the request includes the computing device identifications and the user contexts. In turn, server 430 activates or enables the action to first and second computing devices 410 and 420 based on the received request(s) from first computing device 410, second computing device 420, the third-party provider, or a combination thereof Depending on the used request, server 430 determines the computing device identifications and verifies that the request contains proximity information 414. When server 430 uses more than one request, such as the received request from first computing device 410 and the received request from second computing device 420, the server compares the received requests and proximity information 414 contained therein. For example, each used request comprises identifications of first and second computing devices 410 and 420. As such, server 430 verifies that the same identification information is included in both requests. Moreover, when server 430 uses the request received from the third-party provider, server 430 verifies that first and second computing devices 410 and 420 were in proximity of the third-party provider within a predefined time range.

In addition to verifying the proximity information comprised in the request, server 430 may also require first and second computing devices 410 and 420 to be at a certain venue at a certain time, such as a classroom of a local college for an evening course starting at six o'clock. Server 430 determines the geographic location and time stamp information associated with first and second computing devices 410 and 420 as described herein above, compares the information to the additional requirements, and validates the request accordingly. Alternatively, a third-party provider configured to exchange proximity information is located at the venue. The third-party provider transmits the required proximity information and the time at which the information was acquired to server 430. In turn, server 430 uses such information to validate the request accordingly. For example, if server 430 determines that the first and second users accepted the offer but only the first user attended the course, then the server activates the action for the first user and declines to activate the action for the second user.

Server 430 further authenticates the request based on the computing device identifications and the user contexts. For example, the server determines that second computing device 420 has not been previously registered with server 430. As such, server 430 declines to reward the hundred free credits to the second user. Instead, server 430 sends a response message to second computing device 420 providing instructions for registering second computing device 420 and includes a new enticing offer to encourage the second user to register second computing device 420. Similarly, server 430 determines that the first user has previously redeemed the offer and is fifty credits away from a monthly allowable credit limit. As such, server 430 modifies the service and, instead, credits the first user account with only fifty free credits. Server 430 further transmits a response message 416 to the first computing device 410 as shown in FIG. 4C. Response message 416 describes the activated service and provides further instructions. For example, the activation message comprises a “Learn More” tab that, when selected by the first user, provides additional information about the offer, other offers, the service, other services, the first user account, etc.

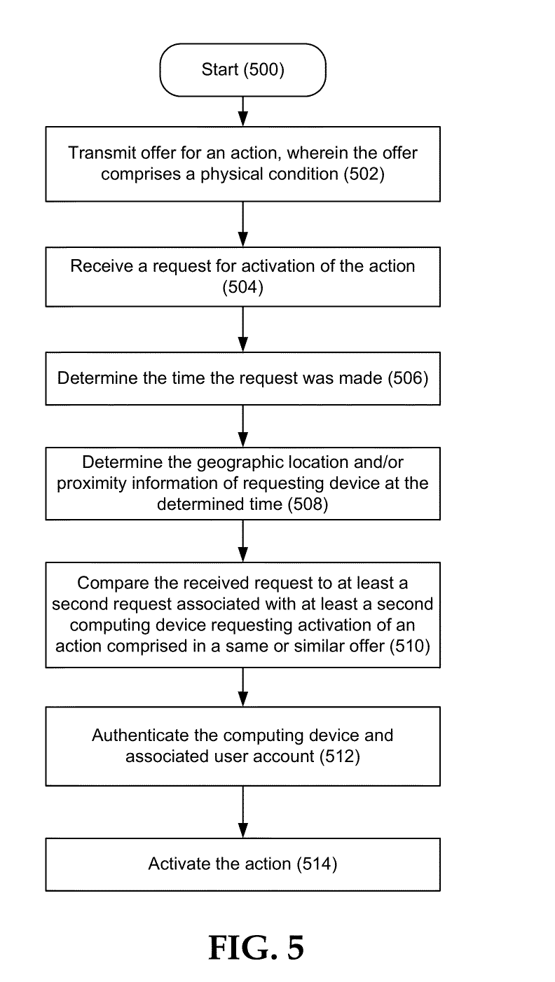

FIG. 5 depicts an example operational procedure for providing an online action including operations 500, 502, 504, 506, 508, 510, 512, and 514. Operation 500 starts the operational procedure, where a server determines an offer for an action to transmit to a computing device. For example, the server and the computing device comprise some or all components of servers 330 and 430 and first computing devices 310 and 320 of FIGS. 3 and 4, respectively. The determination of the offer is based on at least an identification of the computing device and a user context associated with the computing device. The action is based on an incentive-based system and comprises online and real-world rewards redeemable by accepting users. Further, the offer comprises an acceptance condition. For example, the condition comprises real-world physical conditions as described herein above. Operation 500 may be followed by operation 502. Operation 502 (transmit offer for an action, wherein the offer comprises a physical condition) illustrates transmitting the offer from the server to the computing device. Operation 502 may be followed by operation 504. Operation 504 (receive a request for activation of the action) illustrates receiving at the server a request from the computing device to activate the service. The request includes a combination of geographic location and time stamp information associated with the computing device, the time at which the request was transmitted, and proximity information of the computing device to other computing devices.

Operation 504 may be followed by operation 506. Operation 506 (determine the time the request was made) illustrates the server determining the time at which the request was made. Such time corresponds to the time the request was transmitted from the computing device or the time the request was received at the server. Operation 506 may be followed by Operation 508. Operation 508 (determine the geographic location and/or proximity information of requesting device at the determined time) illustrates the server determining the geographic location and/or proximity information of the computing device at the determined time under Operation 506. The determination of the geographic location and/or proximity information is based on the received request or is retrieved from a third-party provider. Operation 508 may be followed by Operation 510.

Operation 510 (compare the received request to at least a second request associated with at least a second computing device requesting activation of an action comprised in a same or similar offer) illustrates the server comparing the received request to at least a second request associated with at least a second computing device. The second request can comprise an acceptance of a same or a similar offer to the offer received at or accepted by the computing device. The second request also comprises similar information to what is described under Operation 504, wherein the information is associated with the second computing device. As such, the server also determines a geographic location, proximity information, and a time estimate for the second request as described under Operations 506 and 508. The comparison between the requests comprises verification that the difference between the determined geographic locations and the difference between the determined times meet the physical condition and/or the proximity information of both computing devices match.

Operation 510 may be followed by Operation 512. Operation 512 (authenticate the computing device and associated user account) illustrates the server authenticating the computing device and the associated user account. The server derives, for example, authentication credentials of the computing device and the user account from the received request. Operation 512 may be followed by Operation 514. Operation 514 (activate the action) illustrates the server activating the action. For example, the server sends a response to the computing device. The response comprises data corresponding to the requested action and a message describing a status of the activation. One skilled in the art will appreciate that, for this and other operational procedures and methods disclosed herein, the operations and methods may be implemented in a different order. Furthermore, the outlined operations are only provided as examples, and some operations may be optional, combined into fewer operations, or expanded into additional operations.

While the invention has been described with reference to a preferred embodiment thereof, it will be understood by one skilled in the art that various changes in form and detail may be made without departing from the scope of the present disclosure. Accordingly, the various embodiments disclosed herein are not intended to be limiting, with the true scope being indicated by the following claims.

What is claimed:

1. A method for enabling actions on computing devices, comprising:
in response to receiving a request for an action, wherein the request is associated with a first computing and a second computing device, verifying that a physical condition is met between the first computing device and the second computing device; and
activating the action based on the verification.

2. The method of claim 1 further comprises transmitting an offer for the action to the first computing device and the second computing device.

3. The method of claim 2, wherein the offer is based on device identifications, user contexts, geographic locations, or physical proximities associated with the first computing device and the second computing device.

4. The method of claim 3, wherein each user context comprises a combination of an account, a profile, a history of offered actions, and a history of enabled actions associated with a user of the computing device.

5. The method of claim 2, wherein the offer is transmitted automatically or upon request to the first computing device and the second computing device.

6. The method of claim 1, wherein the action is derived from an incentive-based system and comprises a combination of reward points, credits, coupons, virtual currency, and tokens.

7. The method of claim 1, wherein the request is received from the first computing device, from the second computing device, a third party provider, or a combination thereof

8. The method of claim 1, wherein verifying that the physical condition is met comprises determining that the first computing device and the second computing device are in proximity of each other.

9. The method of claim 8, wherein the proximity is determined based on using any of a near field communication, short distance communication, optical communication, and sensor-based hardware and software configured for proximity detection.

10. The method of claim 8, wherein the proximity is determined based on a first geographic location of the first computing device and a second geographic location of the second computing device.

11. The method of claim 1, wherein activating the action further comprises authenticating the first computing device, a first user context associated with the first computing device, the second computing device, and a second user context associated with the second computing device.

12. A computer readable storage medium having stored thereon instructions, the computer readable storage medium comprising:
instructions for receiving a request for an action, the request being associated with a first computing device;
instructions for determining that the first computing device meets a physical condition;
instructions for activating the action based on the determination that the physical condition is met.

13. The computer readable storage medium of claim 12, wherein the request for an action comprises a combination of an identification of the first computing device, a user account, a first geographic location of the first computing device at a time the request was made, a proximity at the time the request was made of the first computing device to a second computing device associated with a similar request.

14. The computer readable storage medium of claim 13, wherein the physical condition comprises a requirement for the first computing device to be in proximity of the second computing device.

15. The computer readable storage medium of claim 14, wherein the proximity is determined based on using near field, short distance, or optical communications between the first computing device and the second computing device, or between the first computing device, the second computing device, and a third party provider.

16. The computer readable storage medium of claim 15, wherein the third party provider comprises a third computing device, a tag, a bar code, or a RFID chip.

17. The computer readable storage medium of claim 14, wherein the proximity is determined based on the first geographic location of the computing device and a second geographic location of the second computing device, and wherein verifying that the physical condition is met comprises verifying that the first geographic location and the second geographic location meet a predefined geographic condition and a predefined time condition.

18. A system for activating an action, the system comprising:
a processor; and
a memory communicatively coupled to the processor, the memory bearing processor instructions that, when executed by the processor, cause the system to at least:
receive an offer for an action, wherein the offer comprises a condition for activating the action, and wherein the condition is based on physical proximity of the system and a computing device;
send a request to activate the offer; and
receive an activation of the action, wherein the activation is based on a verification that the condition is met.

19. The system of claim 18, wherein the proximity is determined based on using near field, short distance, radio frequency identification, or optical communications between the system and the computing device.

20. The system of claim 18, wherein the proximity is determined based on a first geographic location of the system and a second geographic location of the computing device, and wherein verifying that the condition is met comprises verifying that the first geographic location and the second geographic location meet a predefined geographic condition and a predefined time condition.
